(19) United States
(12) Patent Application Publication
(10) Pub. No.: US 2007/0207363 A1
(43) Pub. Date: Sep. 6, 2007

(54) Interconnect set of planar solid oxide fuel cell having flow paths

(75) Inventors: Yau-Pin Chyou, Taipei City (TW); Yung-Neng Cheng, Jhongli City (TW); Kin-Fu Lin, Taipei City (TW)

Correspondence Address: TROXELL LAW OFFICE PLLC;SUITE 1404, 5205 LEESBURG PIKE, FALLS CHURCH, VA, 22041, US

(73) Assignee: Atomic Energy Council - Institute of Nuclear Energy Research

(21) Appl. No.: 11/367,274

(22) Filed: Mar. 6, 2006

(51) Int. Cl. H01M 8/02; H01M 2/08

(52) U.S. Cl. 429/35; 429/38

(57) ABSTRACT

By adhering substrates in a fuel cell into a substrate set and stacking the substrate sets into a fuel cell stack, a large space for chemical reaction in the stack is formed, and a space required for the stack is greatly saved.

### FIELD OF THE INVENTION

The present invention relates to an interconnect set; more particularly, relates to adhering more than one electricity-generating substrate and adhering more than one interconnect to obtain a small-scaled FC stack with a large scale of chemical reaction are a and a greatly saved space according to user's actual requirements, where operational fluids of the FC stack are evenly and smoothly flowed on surfaces of the interconnects.

### DESCRIPTION OF THE RELATED ART(S)

Energy is the foundation for exploiting the resources on the earth. In another word, the development of the technologies and the exquisite lives we have nowadays are all based on efficiently utilizing all kinds of energies. Nevertheless, electricity is of no doubt the most convenient energy for human; therefore, for centuries, the scientists and the engineers have done many researches to all kinds of energies with so much effort to meet the requirements of economy and society. Fuel cell (FC) is a highly expected green energy in the energy field in the world recently. The governments, researchers, and industrial circles have been allied and associated over strategies, researches and developments of the FC with a hope that such a green energy can be implemented in human's daily life in a short time.

From the viewpoint of system efficiency, the FC has high potential. Especially when combined with a gas turbine, the FC has a very high efficiency on cycling, which is the top among those similar technologies.

During these years, the governments and the fields of automobile, electricity and energy have put much emphasis on FC technologies, which makes FC one of the most potential green energy in the future.

The idea of producing electricity by an electrochemical reaction first appears in 19th century. From then on, scientists have continuously worked on technologies of so called ‘Fuel Cell’ hoping that it can be implemented in human's daily life. Among them, a demo product using Solid Oxide Fuel Cell (SOFC) has been invented for over 100 years. But, during the process of commercializing the FC, some technique obstacles have been come up with. Since 1960s, some researchers have worked on developing the technology of a tubular SOFC as well as an SOFC electricity generation system, which are considered as a restarting of the developing of such a technology. In mid-1980s, there is a breakthrough in the packaging technology of a planar SOFC, which makes the cost become more competitive to that of a tubular SOFC. Hence, most of the companies or researchers (covering all over America, Europe, Japan, Australia, etc.) focus on the development of a planar system.

Interconnect is one of the key components in a SOFC, which is made of a kind of ceramic or metal. The main function of an interconnect is to link the cathode and the anode of two adjacent single-cell while playing a role as a physical barrier. A reduction environment is protected here by isolating an electrode of air and an electrode of fuel. Just the like, an oxidation environment is also protected by isolating an electrode of fuel and a n electrode of air. Thus, an interconnect has to meet the following conditions:

(a) Under the working temperature of a SOFC, the interconnect has to be of good conductivity.

(b) Under the temperature of 800° C. of a reduction environment or of an oxidation environment, the interconnect has to be of a proper size, micro structure, chemical property and phase stability.

(c) The permeation between the oxygen and the hydrogen has to be reduced in the interconnect to avoid direct interaction.

(d) Under the environment of room temperature or high temperature, the thermal expansion coefficient of the interconnect has to be comparable to that of the adjacent components.

(e) Under the environment of high temperature, diffusion reactions between the interconnect and the adjacent components have to be prevented.

(f) The interconnect has to be of good thermal conductivity.

(g) The interconnect has to be well anti-oxidative, anti-vulcanized and anti-carbonized.

(h) The interconnect has to be obtained and produced easily to lower the cost.

And, (i) the interconnect has to be of good high-temperature strength and be anti-creepy.

Now, a metal interconnect for SOFC has become the main stream, which can be chromium-based or iron-based. A chromium-based interconnect appears in earlier day with higher temperature strength while with more cost, more difficult producing process and worse expansibility as comparing to those of an iron-based one. Therefore, the trends on the interconnect development now is on developing an iron-based interconnect. Besides, if the operation temperature of a SOFC can be lowered to 700° C., a ferritic stainless steel can be used as a material for producing an interconnect with greatly lowered cost.

Considerations for a general interconnect of a SOFC are usually on the number of the inlets and outlets and their positions, yet seldom on the uniformness of the velocity of the operation flows in the flow channel of the interconnect. Often, the lesser the number of the inlets and outlets is, the slower the velocity of the fluid in the flow channel is. On the contrary, the more the number of the inlets and outlets is, the faster the velocity of the fluid is, although with a more complex design as a whole, with an increased complexity in production, and with a much more cost. Consequently, there are few SOFCs that comprise more than three inlets and outlets for an operation flow. Please refer to FIG. 12, which is a view showing flow paths of a prior art. As shown in the figure, the interconnect comprises two inlets and one outlet, where the velocity of the operation flow is distributed evenly and the velocity of the operation flow between the inlets and the outlet is higher than that at two sides.

In “Three-dimensional thermo-fluid electrochemical modelling of planar SOFC stacks” by K. P. Recknagle, R. E. Williford, L. A. Chick, D. R. Rector, and M. A. Khaleel (Journal of Power Sources, 113, pp. 109-114, 2003), the impacts on the distribution of the temperature as well as current density in an electricity-generating substrate with a flow channel deployment of cross-flow, co-flow or counterflow are discussed. In general, the distribution of the temperature as well as current density with a flow channel deployment of co-flow is most even; the fuel utilization with a flow channel deployment of counterflow is higher; and the highest distribution of the temperature as well as current density with a flow channel deployment of cross-flow is at the interflow of the fuel at the inlet and the air at the outlet.

In “3-D model calculation for plane SOFC” by H. Yakabe, T. Oyiwara, M. Hishinuma, and I. Yasuda (Journal of Power Sources, 102, pp. 144-154, 2001), an analysis model for a flow channel is established to efficiently analyze the velocity distribution in the flow channel. The inlet and outlet of the flow channel are in an anti-symmetrical design with one inlet and one outlet. The emphasis is only on the calculation of the velocity distribution in the flow channel.

In “Material research for planer SOFC stack” by T.-L. Wen, D. Wang, M. Chen, H. Tu, Z. Zhang, H. Nie and W. Huang (Solid State Ionics, 148, pp 513-519, 2002), the materials for the components of a FC stack are described with a figure of the components of the FC stack (as shown in FIG. 13). The flow channel of an interconnect is deployed as a cross-flow channel with a symmetrical design of two inlets and two outlets, yet in lack of considering the uneven velocity in the flow channel.

The German patent of DE10039024A1 is a method for assembling a glass-ceramics-sealed SOFC stack. A co-flow for a glass-ceramics-sealed SOFC stack is designed, where the flow directions of the fuel and the air are the same; flow are as are formed by ribs and furrows in an interconnect; yet the design of the number of inlets and outlets and the detail design of the flow area are not described.

The above prior arts provide no solution for the problems concerning a large-scaled electricity-generating substrate, such as weak structural robustness, limited chemical reaction are a, big space requirement and little electricity generation per certain are a. Hence, the prior arts do not fulfill users' requests on actual use.

### SUMMARY OF THE INVENTION

The main purpose of the present invention is to adhere more than one electricity-generating substrate and adhere more than one interconnect to obtain a small-scaled FC stack with a large scale of chemical reaction are a and a greatly saved space according to user's actual requirements, where operational fluids of the FC stack are evenly and smoothly flowed on surfaces of the interconnects.

To achieve the above purpose, the present invention is an interconnect set of a planar SOFC having flow paths, comprising an interconnect set and a seal, where more than one interconnect is adhered to each other according to user's actual requirements to obtain the interconnect set; each interconnect comprises a first flow area and a second flow area; the first flow area is deposed on a surface of the interconnect; the first flow area has a first channel; the first flow area has more than one first inlet at an end connected with the first channel and has a first outlet at the opposite end connected with the first channel; the second flow area is deposed on the other surface of the interconnect; the second flow area has a second channel; the second flow area has more than one second inlet at an end connected with the second channel and has a second outlet at the opposite end connected with the second channel; two second inlets are deposed at two sides of a first outlet of the first flow area; the second outlet is deposed between two first inlets of the first flow area; each of the first and the second channels has a plurality of ribs; every two adjacent ribs have a vertical or horizontal furrow in between; flow paths are obtained on each of the first and the second flow are as by serially connecting a plurality of furrows; the seal is correspondingly deposed over rims of the interconnect set to prevent operational fluids from leaking out or mixing up; and, by adhering the interconnects in a serial and/or parallel way according to user's actual requirements, a large scale of chemical reaction are a is obtained, difficulties in assembling an FC stack is reduced, and a great sum of space is saved. Accordingly, a novel interconnect set of a planar SOFC having flow paths is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view showing a surface of a preferred embodiment according to the present invention;

FIG. 2 is a perspective view showing the other surface of the preferred embodiment according to the present invention;

FIG. 3 is an explosive view showing an assembly of the preferred embodiment according to the present invention;

FIG. 4 is a perspective view showing the assembly of the preferred embodiment according to the present invention;

FIG. 5 and FIG. 6 are views showing flow paths of operational fluids according to the preferred embodiment of the present invention;

FIG. 7 is a perspective view showing a surface of another preferred embodiment according to the present invention;

FIG. 8 is a perspective view showing the other surface of the another preferred embodiment according to the present invention;

FIG. 9 is a view showing two interconnects adhered in a serial way according to the preferred embodiment of the present invention;

FIG. 10 is a view showing four interconnects adhered both in a serial and a parallel ways according to the preferred embodiment of the present invention;

FIG. 11 is a view showing another assembly of the preferred embodiment according to the present invention;

FIG. 12 is a view showing flow paths of a prior art; and

FIG. 13 is an explosive view showing an assembly of the prior art.

### DESCRIPTION OF THE PREFERRED EMBODIMENTS

The following descriptions of the preferred embodiments are provided to understand the features and the structures of the present invention.

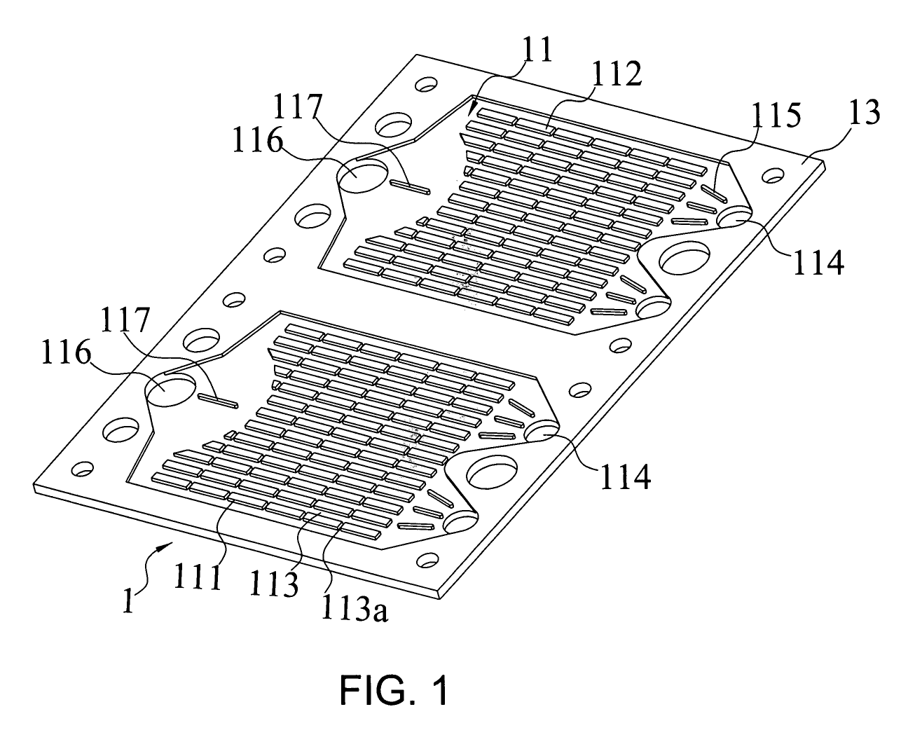

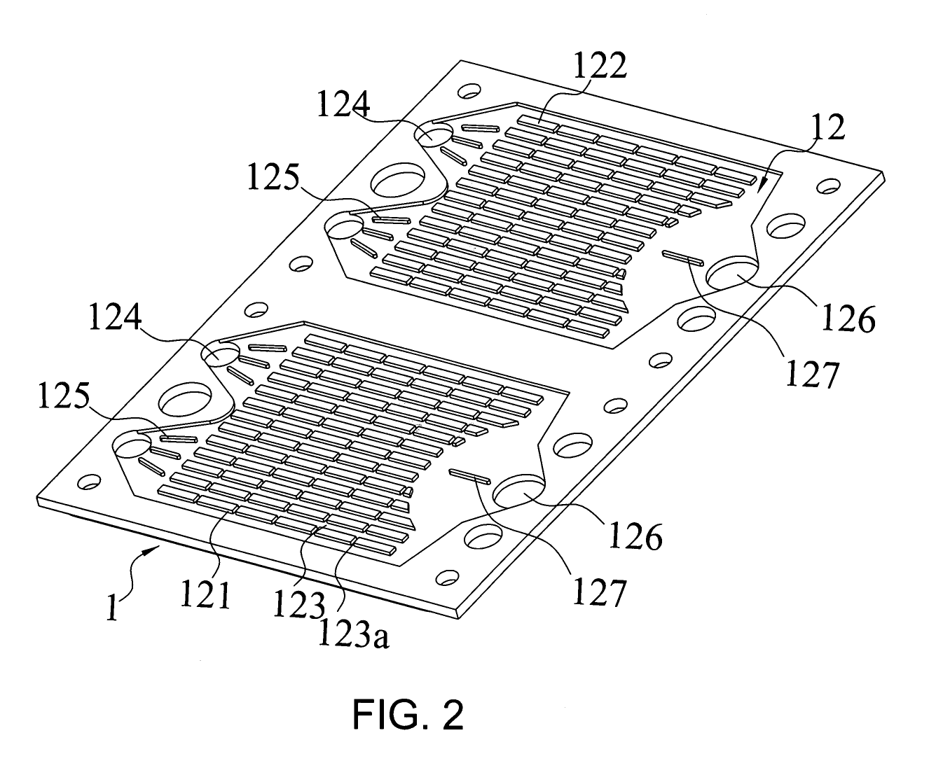

Please refer to FIG. 1 and FIG. 2, which are perspective views showing two opposite surfaces of a preferred embodiment according to the present invention. As shown in the figures, the present invention is an interconnect set of a planar solid oxide fuel cell (SOFC) having flow paths, comprising an interconnect set 1 and a seal 13.

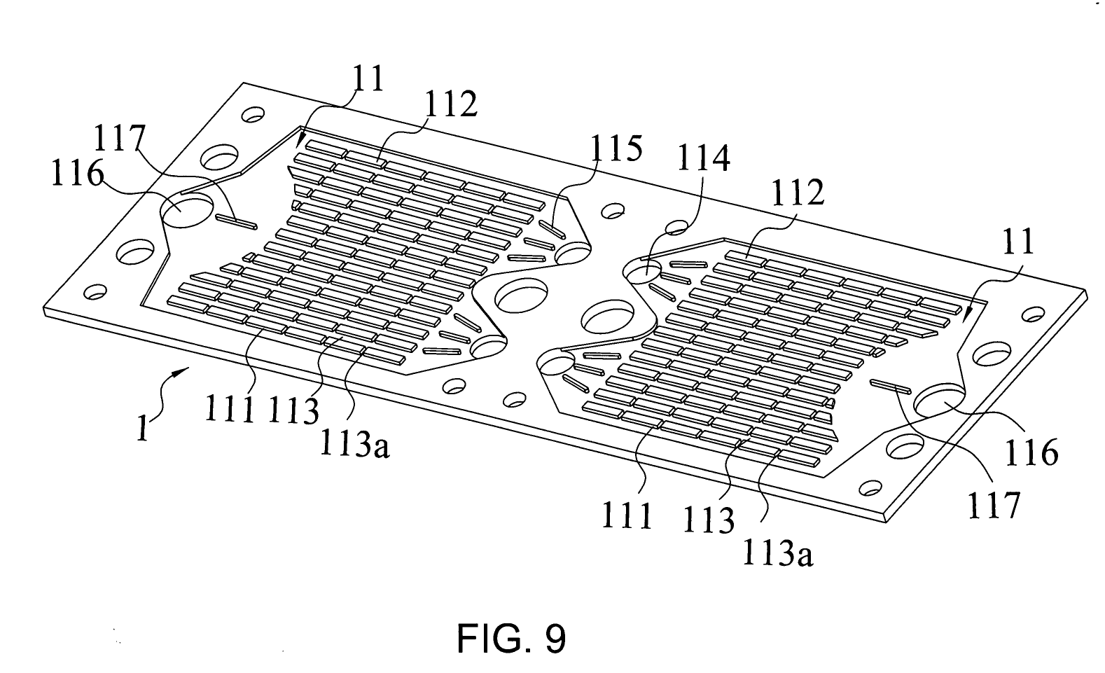

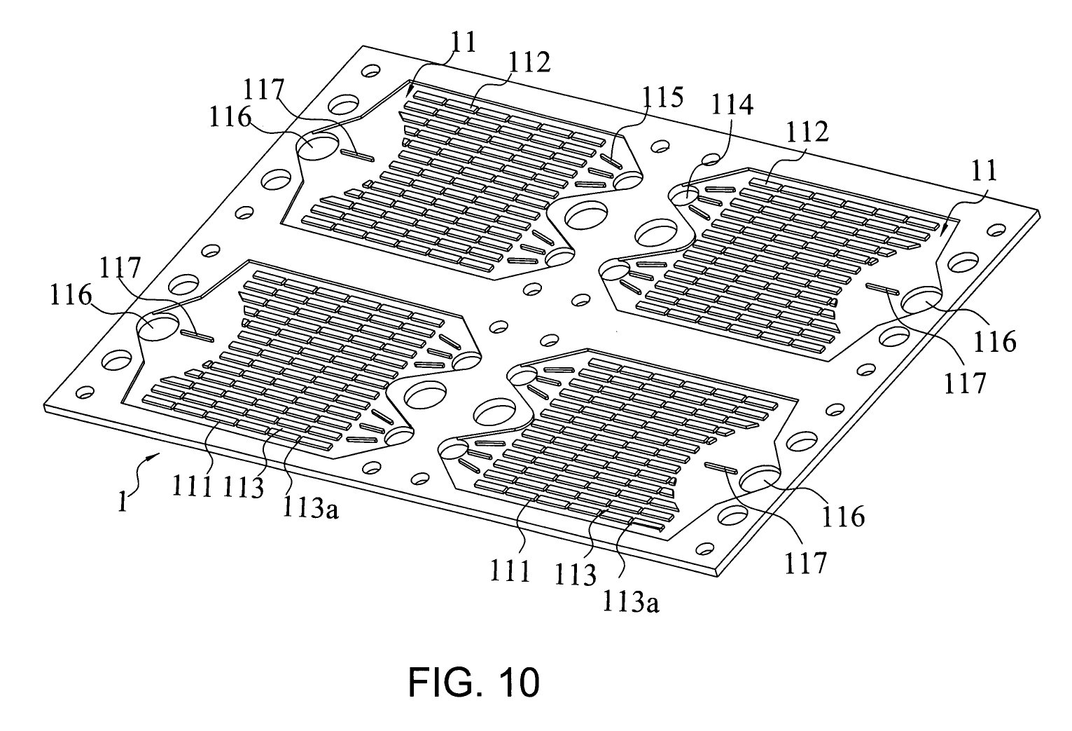

The interconnect set 1 comprises more than one interconnect adhered to each other according to user's actual requirements. (Please refer to FIG. 1, FIG. 9 and FIG. 10 which show interconnects adhered in a parallel way, in a serial way and both in a parallel and a serial ways.) Each interconnect comprises a first flow are a 11 and a second flow area 12. The first flow area 11 is deposed on a surface of the interconnect 1; the first flow area 11 has a first channel 111 more than one first inlet 114 connected with the first channel 111 is deposed at an end of the first flow area 11; and, at least one first outlet 116 connected with the first channel 111 is deposed at the other end of the first flow area 11. The second flow area 12 is deposed on the opposite surface of the interconnect 1; the second flow area 12 has a second channel 121 more than one second inlet 124 connected with the second channel 121 is deposed at an end of the second flow area 12; two second inlets 124 are located at two sides of a first outlet 116 of the first flow area 11; at lease one second outlet 126 connected with the second channel 121 is deposed at another end of the second flow area 12; and, the second inlet 124 is located between two first inlets 114 of the first flow area 11. Each of the first and the second channels 111, 121 has a plurality of ribs 112, 122. A vertical or horizontal furrow 113, 113a, 123, 123a is obtained between every two adjacent ribs 112, 122 so that flow paths are obtained by serially connecting a plurality of furrows 113, 113a, 123, 123a.

The seal 23, 32 is correspondingly deposed over rims of the interconnect set 1 to prevent operational fluids from leaking out or mixing up.

The first and the second channels 111, 121 are respectively deposed curvedly at a brim corresponding to the first and the second outlets 116, 126. A plurality of first deflectors 115, 125 are correspondingly deposed outside of an end of each of the first and the second inlets 114, 124; and, a second deflector 117, 127 is deposed outside of an end of each of the first and the second outlets 116, 126.

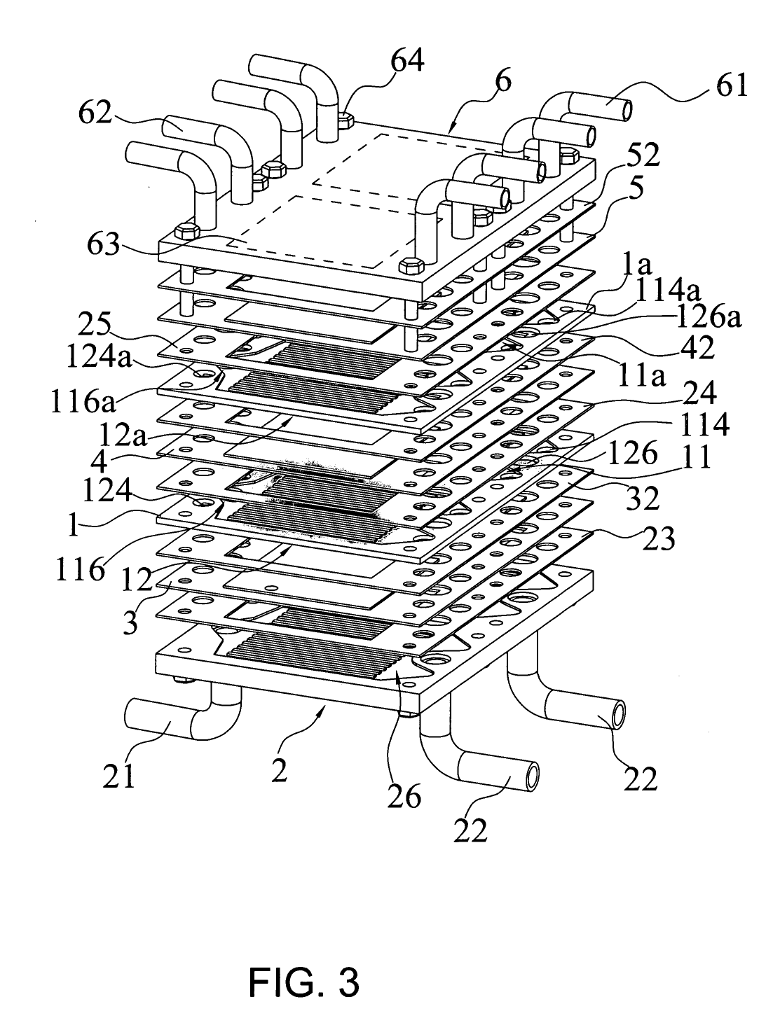

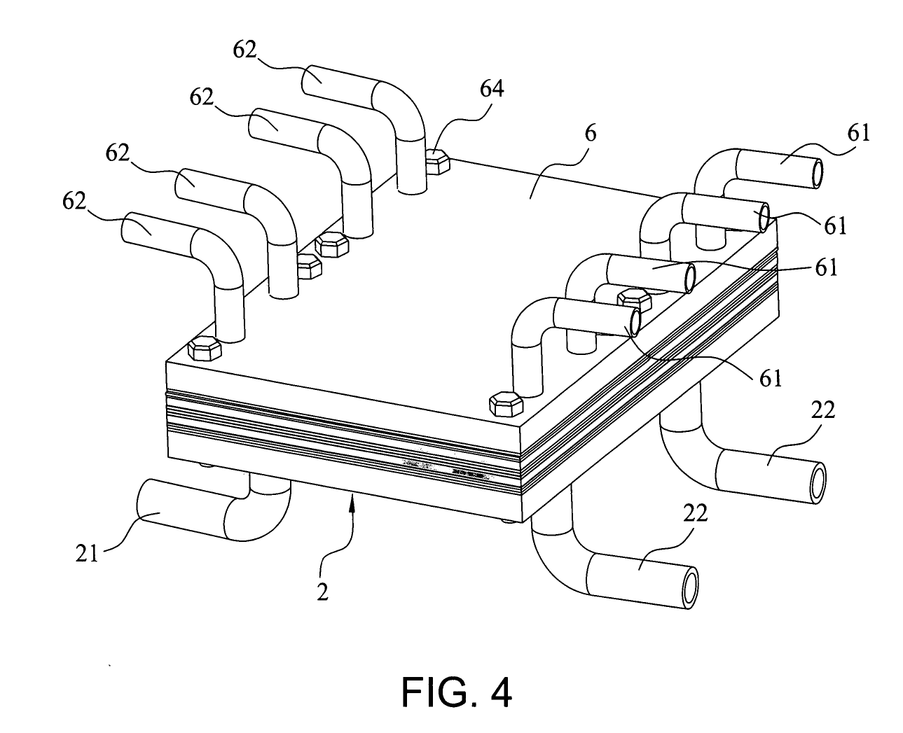

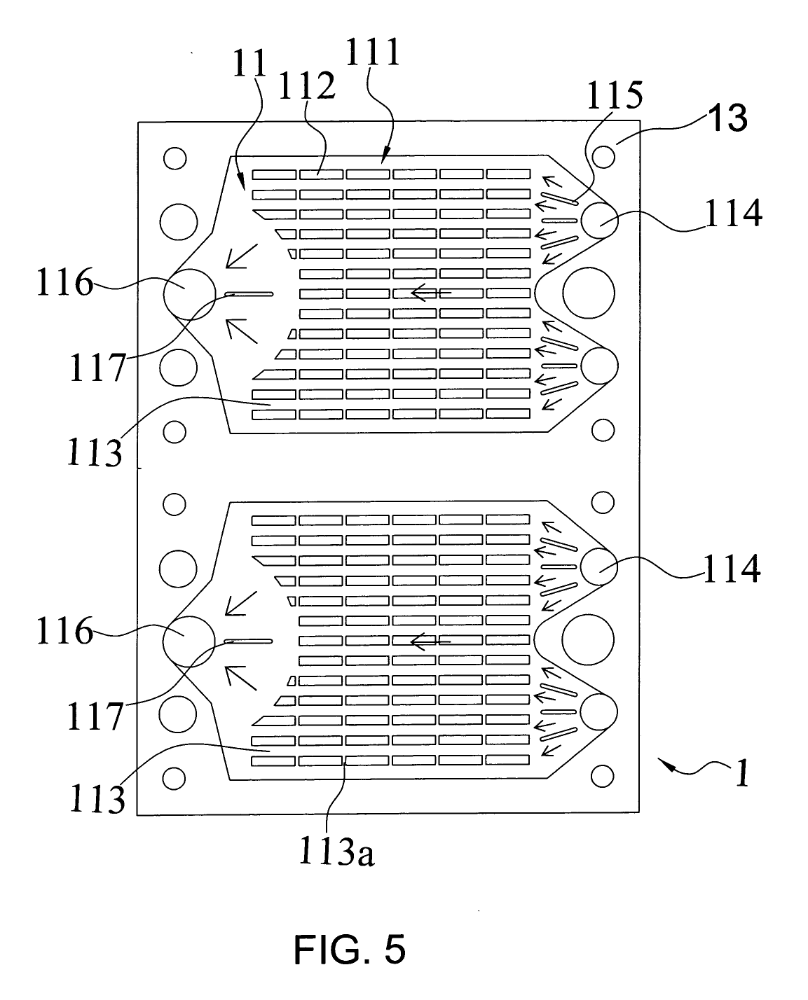

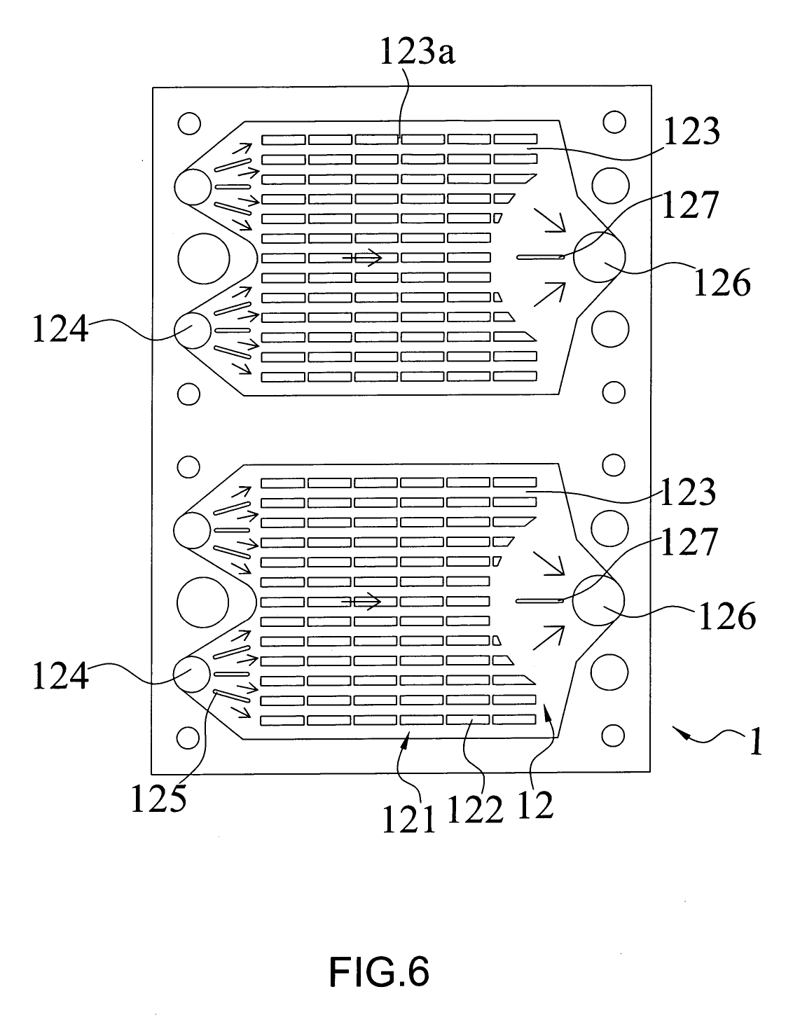

Please refer to FIG. 3 till FIG. 6, which are an explosive and a perspective views showing an assembly, and views showing flow paths of operational fluids, according to the preferred embodiment of the present invention. On assembling the present invention, a pair of two parallel-adhered bases 2 is obtained first, where a first and a second outlet tubes 21, 22 are respectively connected at two ends of the base 2. A pair of parallel-adhered first interconnects 1 is deposed on the bases 2 respectively, and a pair of parallel-adhered second interconnects 1a is deposed on the first interconnects 1 respectively. A pair of parallel-adhered covers 6 is deposed on the second interconnects 1a, w here a first and a second inlet tubes 61, 62 are respectively connected at each of two opposite ends of the cover 6. A pair of parallel-adhered first electricity-generating substrates 3 is respectively deposed between the bases 2 and the first interconnects 1 where seals 23, 32 are deposed between the first electricity-generating substrates 3 and the bases 2 as well as between the first electricity-generating substrates 3 and the first interconnects 1 to prevent operational fluids from leaking out or mixing up. First outlets 116, 116a are respectively corresponding to openings of the first outlet tubes 21; and second outlets 126, 126a at the opposite end are respectively corresponding to openings of the second outlet tubes 22. A pair of parallel-adhered second electricity-generating substrates 4 is deposed between the first interconnects 1 and the second interconnects 1a. The first and the second interconnects 1, 1a are contacted with the second electricity-generating substrates 4 with seals 24, 42 to prevent the operational fluids from leaking out or mixing up. A pair of parallel-adhered third electricity-generating substrates 5 is deposed between the covers 6 and the second interconnects 1a where seals 25, 52 are deposed between the electricity-generating substrates 5 and the second interconnects 1a as well as between the electricity-generating substrates 5 and the covers 6 both to prevent the operational fluids from leaking out or mixing up. First inlets 114, 114a are respectively corresponding to openings of the first inlet tubes 61; and, second inlets 124, 124a at the opposite end are respectively corresponding to openings of the second inlet tubes 62. Third flow are as 26 of the bases 2 are respectively corresponding to second flow are as 12 of the first interconnects 1; first flow are as 11 of the first interconnects 1 are respectively corresponding to second flow are as 12a of the second interconnects 1a; first flow are as 11a of the second interconnects 1a are respectively corresponding to fourth flow are as 63 of the covers 6; and, with the help of locking parts 64, the whole package is locked to assemble a number of interconnects according to user's actual requirements to obtain better utilization.

On using the present invention, a required first operational fluid is directed from the first inlet tubes 61 of the covers 6, where the first operational fluid is guided to flow from the first inlets 114a of the first flow areas 11a on the second interconnects 1a to the first channels 111a of the second interconnects 1a; then to flow from the first channels 111a to the first outlets 116a of the second interconnects 1a; then to flow through the first outlets 116 of the first flow are as 11 of the first interconnects 1; and, finally, to flow directly to the first output tubes 21 of the bases 2. Another portion of the first operational fluid is guided to flow directly from the first inlet tubes 61 of the covers 6 to the first inlets 114 of the first flow are as 11 on the first interconnects 1; then to flow from the first inlets 114 to the first channels 111 of the first interconnects 1; then to flow from the first channels 111 to the first outlets 116 of the first interconnects 1; and, finally, to flow to the first output tubes 21 of the bases 2. The remaining portion of the first operational fluid flows directly from the first inlet tubes 61 of the covers 6 to the third flow are as 26 on the bases 2 to be outputted through the first output tubes 21 of the bases 2.

A second operational fluid is directed to flow from the second inlet tubes 62 of the covers 6 to the second outlets 126a of the second flow are as 12a of the second interconnects 1a through the fourth flow are as 63 of the covers 6; and, finally, to flow directly to the second output tubes 22 of the bases 2. Another portion of the second operational fluid is guided to flow directly from the second inlet tubes 62 of the covers 6 to the second channels 121a of the second interconnects 1a through the second in lets 124a of the second flow are as 12a of the second interconnects 1a; then to flow from the second channels 121a to the second outlets 126a of the second flow are as 12a; and, finally, to be outputted through the second output tubes 22 of the bases 2. The remaining portion of the second operational fluid is guided to flow directly from the second inlet tubes 62 of the covers 6 to the second channels 121 of the first interconnects 1 through the second inlets 124 of the second flow are as 12 of the first interconnects 1; then to flow from the second channels 121 to the second outlets 126 of the second flow are as 12 of the first interconnects 1; and, finally, to be outputted through the second output tubes 22 of the bases 2. With these two different operational fluids of counterflow flowing through the first and second flow are as 11, 11a, 12, 12a adhered to the first 3, the second 4 and the third 5 electricity-generating substrates, electricity is generated.

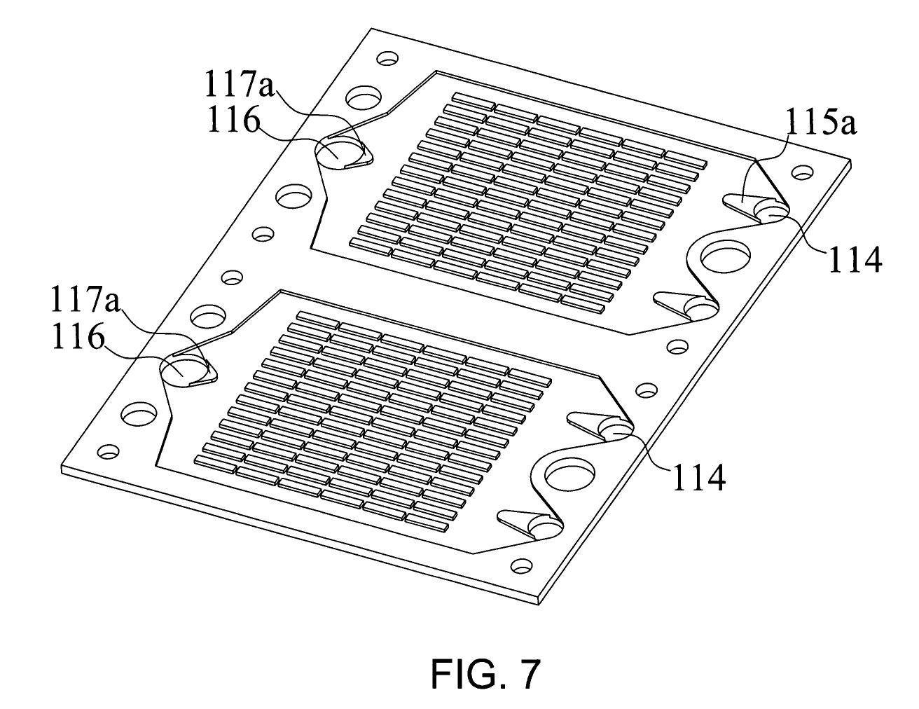

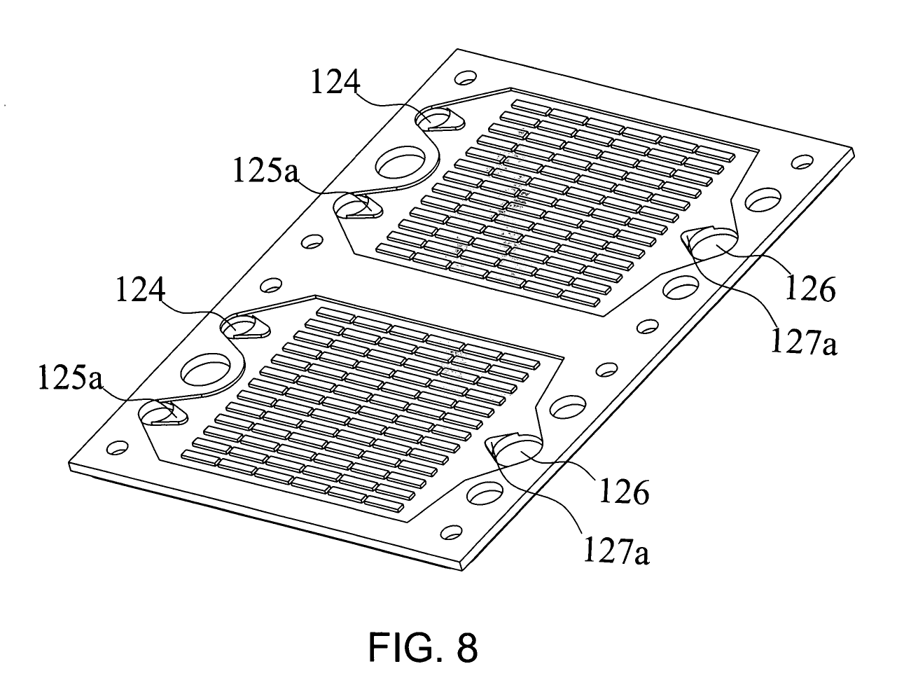

Please refer to FIG. 7 and FIG. 8, which are perspective views showing two opposite surfaces of another preferred embodiment according to the present invention. As shown in the figures, raised first deflectors 115a, 125a are deposed at brims of a first and a second inlets 114, 124; and, raised second deflectors 117a, 127a are deposed at brims of a first and a second outlets 116, 126.

Please refer to FIG. 1, FIG. 9 and FIG. 10, which are a perspective view showing a surface of a preferred embodiment and views showing two interconnects adhered in a serial way and four interconnects adhered both in a serial and a parallel ways, according to the preferred embodiment of the present invention. As shown in the figures, the present invention is characterized in that operational fluids of a fuel cell (FC) are evenly and smoothly flowed through opposite surfaces of interconnects to obtain a good utilization of an FC stack, where the interconnects are adhered according to user's actual requirements to obtain an interconnect set 1. A seal 23, 32 used in the present invention is correspondingly deposed at rims of the interconnect set 1 to prevent operational fluids from leaking out or mixing up. The present invention is a quite direct way for improving the electricity generation efficiency of an F C stack, where an assembly of electricity-generating substrates is coordinated with a variety of the interconnect set 1 and the seal 23, 32. As comparing to assembling an FC stack with electricity-generating substrates of a large scale, the electricity-generating substrates used in the present invention are not broken easily. A large scale are a for chemical reaction is obtained by assembling interconnects in a parallel and/or serial way; the difficulty in disassembling the FC stack is reduced; and, a space used for an assembled FC stack are greatly saved. Moreover, a proper number of interconnects can be assembled according to user's actual requirements to obtain better utilization.

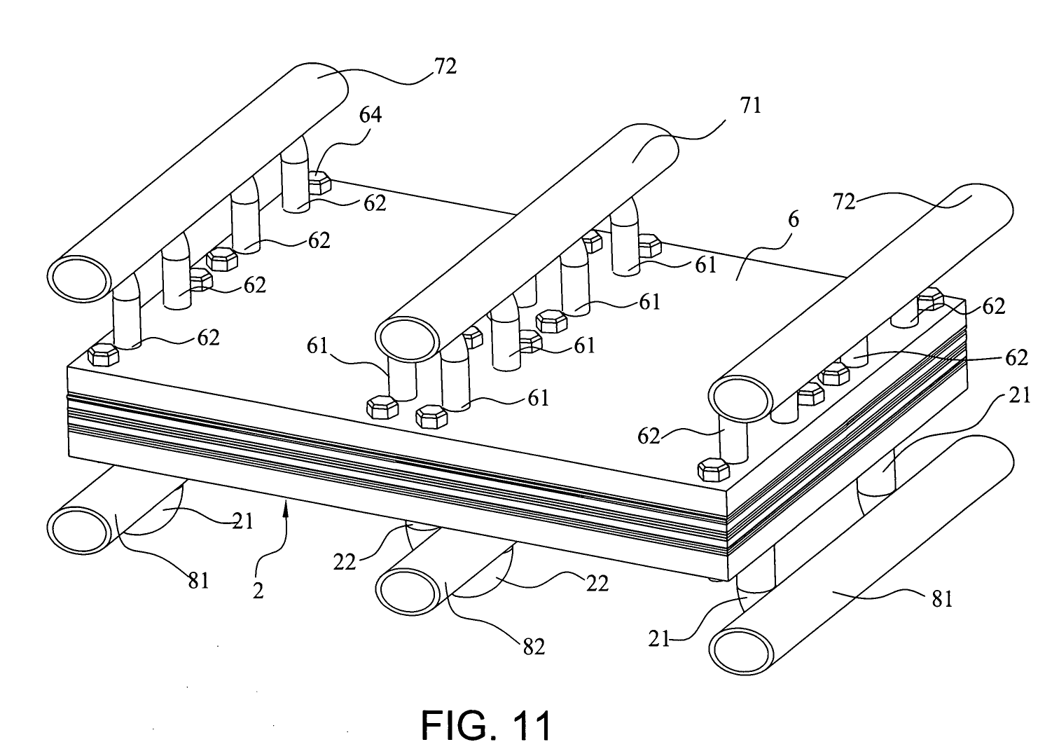

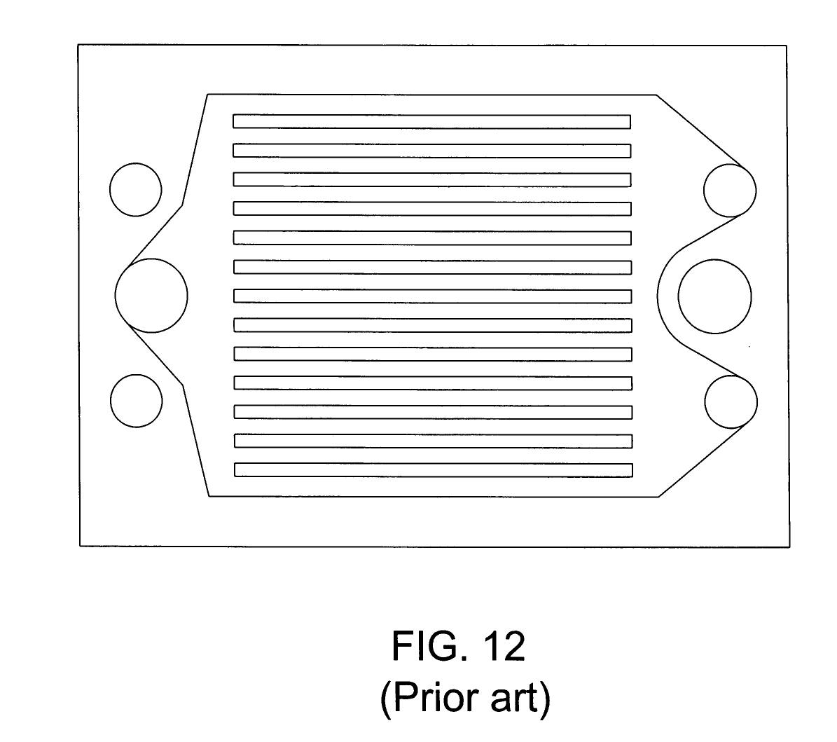

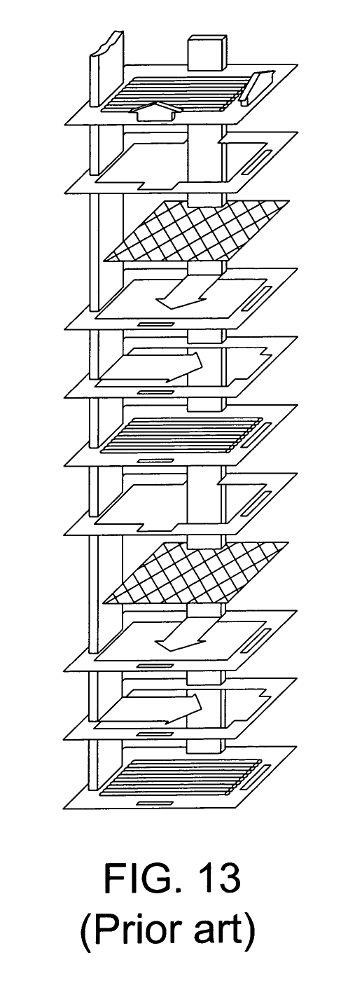

Please refer to FIG. 11, which is a view showing another assembly of the preferred embodiment according to the present invention. As shown in the figure, first and second in let tubes 61, 62 are further connected to supply tubes 71, 72 of operational fluids for filling a first and a second operational fluids. And, first and second outlet tubes 21, 22 of operational fluids are further connected to exhaust tubes 81, 82 of operational fluids for draining the first and the second operational fluids. By the design shown in FIG. 1, FIG. 9 and FIG. 10, the operational fluids are supplied through the inlet tubes 61, 62 by the supply tubes 71, 72 of operational fluids; and are exhausted through the outlet tubes 21, 22 by the exhaust tubes 81, 82 of operational fluids.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. An interconnect set of a planar solid oxide fuel cell having flow paths, said interconnect set comprising:
(a) a plurality of adhered interconnects, said interconnect comprising:
(i) a first flow area, said first flow area comprising
a first channel;
more than one first inlet; and
more than one first outlet; and
(ii) a second flow area, said second flow area comprising
a second channel;
more than one second inlet; and
more than one second outlet; and
(b) a seal,
wherein said first flow area is deposed on a surface of said interconnect, said more than one first inlet is connected with said first channel at an end of said first flow area, and said more than one first outlet is connected with said first channel at the other end of said first flow area;
wherein said second flow area is deposed on the other surface of said interconnect, said more than one second inlet is connected with said second channel at an end of said second flow area, two said second inlets are deposed at two sides of said first outlet of said first flow area, said more than one second outlet is connected with said second channel at the other end of said second flow are a, and said second outlet is deposed between two said first inlets of said first flow area;
wherein each channel of said first channel and said second channel has a plurality of ribs, a furrow is located between each two adjacent ribs, said furrow is selected from a group consisting of a vertical furrow and a horizontal furrow, and a plurality of said furrows is serially connected to obtain a plurality of flow paths; and
wherein said seal is correspondingly deposed over rims of said interconnect set to prevent operational fluids from leaking out.

2. The interconnects according to claim 1
wherein said interconnects are adhered in a parallel way.

3. The interconnects according to claim 1,
wherein said interconnects are adhered in a serial way.

4. The interconnects according to claim 1,
wherein said interconnects are adhered both in a parallel and a serial ways.

5. The interconnects according to claim 1,
wherein said first inlet is connected with a first inlet tube.

6. The interconnects according to claim 5,
wherein said first inlet tube is connected with a supply tube of an operational fluid.

7. The interconnects according to claim 1,
wherein said first outlet is connected with a first outlet tube.

8. The interconnects according to claim 7,
wherein said first outlet tube is connected with an exhaust tube of an operational fluid.

9. The interconnects according to claim 1,
wherein said second inlet is connected with a second inlet tube.

10. The interconnects according to claim 9,
wherein said second inlet tube is connected with a supply tube of an operational fluid.

11. The interconnects according to claim 1,
wherein said second outlet is connected with a second outlet tube.

12. The interconnects according to claim 11,
wherein said second outlet tube is connected with an exhaust tube of an operational fluid.
